(19) United States
(12) Patent Application Publication
(10) Pub. No.: US 2026/0237396 A1
(43) Pub. Date: Aug. 13, 2026

(54) STREAMING NEURAL NETWORK PROCESSOR FOR LOW LATENCY AUDIO PROCESSING

(71) Applicant: Analog Devices, Inc., Wilmington, MA (US)

(72) Inventors: Tao YU, Needham Heights, MA (US); Vivek Prakash NIGAM, Wilmington, MA (US); Arpit SHAH, Austin, TX (US)

(21) Appl. No.: 19/471,497

(22) PCT Filed: Apr. 1, 2024
(86) PCT No.: PCT/US2024/022466

§ 371 Date: Oct. 1, 2025

Related U.S. Application Data
(60) Provisional application No. 63/457,317, filed on Apr. 5, 2023.

(51) Int. Cl. G10L 25/30; G10L 21/0216

(52) U.S. Cl. CPC G10L 25/30; G10L 21/0216; G10L 2021/02165

(57) ABSTRACT

Aspects of the present disclosure include low-latency devices and methods for reducing interference on streaming signals. A device for reducing interference on a streaming signal in accordance with an aspect of the present disclosure may include a first sensor for receiving an input interference comprising a first interference and a second interference, a second sensor for receiving a residual portion of the first interference and an input signal, an output device for producing an output signal from the input signal, and a neural network for processing at least an output of the first sensor to reduce an effect of the second interference on the input signal.

### BACKGROUND

### Technical Field

The present disclosure generally relates to streaming data, and more particularly, to a streaming neural network processor for low latency audio processing.

### Introduction

As the sample rates of converters are increased, circuits with incomplete settling parameters may be used to reduce power consumption and still achieve the desired high sample rates. The incomplete settling of these circuits results in gain error and other non-ideal conditions for the converters.

With the popularization of smartphones, the use and enjoyment of audio and visual media has become widespread. Viewing streaming video programs, and listening to streaming audio for video programming and audio programs such as music and podcasts now takes place virtually anywhere. The audio portion of such streaming (or locally stored or broadcast via Bluetooth or wi-fi) is often delivered to the listener by headphones, earbuds, or earphones, which can be electronically coupled to a smartphone by Bluetooth or wires. Headphones, earbuds, etc. are generally small speakers that are designed to be held in place close to or within a listener's ears, and are designed to allow a single user to listen to an audio source privately.

Because headphones, earbuds, etc. are now used in various environments, there has also been an increase in the use of noise-cancelling systems to allow the desired audio (from the music, video, podcast, etc.) to reach the listener's ears without the ambient noise of the environment where the listener is located. Since the listener may be located in a wide variety of environments, active noise-cancelling systems may be used to determine the noise in the environment and reduce or eliminate the environmental noise from reaching the listener's ears.

Active noise control systems may use various filtration techniques to process the source audio signals in order to reduce the influence of noise on the listener. This may be accompanied by modification of the source audio by combination with an “anti-noise” signal derived from comparing ambient sound to source audio at the ear of a listener.

Active noise-cancelling devices may suffer from being incapable of addressing the wide variation of ambient noise, specific types of ambient noise such as wind noise, the nature and characteristics of the source audio, or the type of headphones being used, in order to provide the listener with a better sound experience.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

A device for reducing interference on a streaming signal in accordance with an aspect of the present disclosure may include a first sensor for receiving an input interference comprising a first interference and a second interference, a second sensor for receiving a residual portion of the first interference and an input signal, an output device for producing an output signal from the input signal, and a neural-network for processing at least an output of the first sensor to reduce an effect of the second interference on the input signal.

Such a device may further optionally include a processor for processing the output of the first sensor and an output of the second sensor, the processor being a digital signal processor, the processor further comprising at least one filter, and the at least one filter being a biquadratic filter.

Such a device may further optionally include the neural network being coupled to the processor in series or in parallel, a detector, coupled to the output of the first sensor and to the neural network, for detecting the second interference, the detector enabling at least a portion of the neural network when the second interference is detected, the second interference comprising an increased energy level within a specified frequency range. the second interference being wind noise, the input signal being an audio signal, and the neural network being a long short term memory network.

A method for reducing interference on a streaming signal in accordance with an aspect of the present disclosure may include receiving an input interference comprising a first interference and a second interference at a first sensor, receiving a residual portion of the first interference and an input signal at a second sensor, producing an output signal from the input signal, and processing at least an output of the first sensor at a neural network to reduce an effect of the second interference on the input signal.

Such a method further optionally includes coupling a processor to the neural network and processing the output of the first sensor and an output of the second sensor at the processor, the processor is coupled to the neural network in series or in parallel, and detecting the second interference and enabling at least a portion of the neural network based on the detection of the second interference.

Such a method further optionally includes the first sensor and the second sensor being microphones, the input signal being an audio signal, and the neural network being a long short term memory network.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 illustrates a block diagram of a device in accordance with an exemplary aspect of the present disclosure.

FIG. 2 is a block diagram of a device in accordance with an exemplary aspect of the present disclosure.

FIG. 3 is a block diagram of a device in accordance with an exemplary aspect of the present disclosure.

FIG. 4 is a block diagram of a device in accordance with an exemplary aspect of the present disclosure.

FIG. 5 is a flow diagram in accordance with an exemplary aspect of the present disclosure.

FIG. 6 is a diagram of a neural network in accordance with an exemplary aspect of the present disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

### Overview

The present disclosure describes a digital architecture with a low latency neural network accelerator combined with a per-sample audio processing, such as a fast Digital Signal Processor (DSP), for applications such as active noise cancellation (ANC), hearing assistance (HA), and/or hearing transparency (HT). An architecture in accordance with an aspect of the present disclosure may comprise a neural network data path, which may be an optimized neural network data path, for per-sample streaming use cases, and, when combined with the DSP, allows for low latency audio processing.

Some approaches to ANC, HA, and HT are performed with low-latency linear filter processing, e.g., biquadratic (“biquad”) filters, because ANC and HT typically have processing times of less than 10 microseconds (μs). If processing times are greater than 10 μs, the noise cancellation does not end up cancelling the ambient noise, and instead adds to the noise experienced by the listener. The limitations of linear filter processing result in challenges in ANC and HT in certain situations, such as wind noise reduction.

Wind noise often presents on a feed-forward (FF) microphone, as opposed to a feedback (FB) microphone, and is attenuated due to physical isolation of the earbuds and/or headphones. Because wind noise is often found in the lower frequencies of human sound detection, it overlaps with some other sounds such as human speech and lower frequency audio programming. This overlap in frequencies reduces the effectiveness of linear filter processing and traditional DSP algorithms in reducing the effect of wind noise in ANC systems.

In the present disclosure, a neural network can be used to overcome the linear filter processing and traditional DSP algorithms while maintaining speech frequencies and speech quality. Some neural networks, if block-based processing were to be used, may result in long latency (>10 μs) which would not be applicable to ANC and HT. However, the streaming neural network of the present disclosure improves and/or optimizes the data path bottleneck of the network to enable the network processing to be completed within the 10 μs time frame.

### Noise Canceling Devices

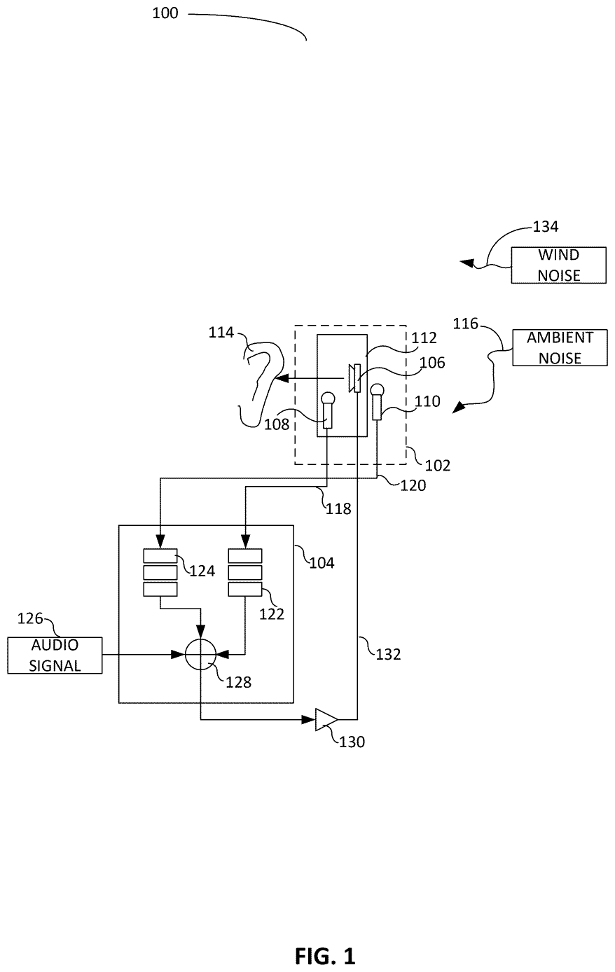

FIG. 1 illustrates a block diagram of a device in accordance with an exemplary aspect of the present disclosure.

System 100 illustrates an earpiece 102 and a processor 104. Earpiece 102 may include, inter alia, a speaker 106, a feedback microphone (FB mic) 108, and a feed-forward microphone (FF mic) 110. Speaker 106 and FB mic 108 may be enclosed in enclosure 112.

System 100 may be used with signals that are being received or transmitted continuously, e.g., audio signals. As such, system 100 may be used in a “streaming” environment. A streaming environment may include transmitting or receiving data, such as video and/or audio material over a computer network, in a steady, continuous flow. In such environments, playback of the signal may start while the remainder of the data is still being received by system 100.

Earpiece 102 may be, for example, an earbud, earphone, or an earpiece of a pair of headphones, which can be placed in proximity to a listener's ear 114. In the case of earbuds or earphones, earpiece 102 may be placed in the outer ear canal of ear 114, while in the case of headphones, earpiece 102 may be placed on or around ear 114.

Speaker 106 may be a small loudspeaker, which may be an electroacoustic transducer that converts an electrical audio signal into a sound that can be received by ear 114. Speaker 106 may be a motor attached to a diaphragm which couples the motor's movement to motion of air to reproduce sound.

FB mic 108 and FF mic 110 are microphones that detect sound by converting sound waves to mechanical motion with a diaphragm, and the mechanical motion of the diaphragm is then converted to an electrical signal. FB mic 108 is inside of enclosure 112, which may be an earpiece of a headphone or part of an earbud. FF mic 110 is external to enclosure 112. FB mic 108 receives sound that is closer in amplitude to what ear 114 perceives, and may not include sounds that FF mic 110 receives, as the placement of enclosure 112 may attenuate or eliminate some sounds from reaching ear 114.

FB mic 108 and FF mic 110 may be condenser microphones, where the diaphragm of the microphone acts as one plate of the capacitor, and the vibration of the diaphragm changes the distance between the plates. FB mic 108 and FF mic 110 may be fiber optic or “optical” microphones, MEMS (MicroElectrical-Mechanical System) microphones, microphone chips or silicon microphones, or other types of microphones, without departing from the scope of the present disclosure.

FB mic 108 and FF mic 110 may be directional microphones, omni-directional microphones, cardioid microphones, or other types of sensitivity patterns. Further, FB mic 108 may have a different sensitivity pattern than FF mic 110.

FB mic 108 and FF mic 110 may also be other types of sensors, e.g., vibration sensors, motion sensors, piezoelectric sensors, etc. to detect other types of physical stimuli that are converted to sound that reach ear 114.

As shown in FIG. 1, FB mic 108 and FF mic 110 may be used as in system 100 to cancel noise, such as ambient noise, when system 100 is used in a noisy environment. Ambient noise 116 may be present in the environment where system 100 is used, and ambient noise 116 may reach ear 114 and interfere with the desired sounds the user wishes to hear. Ambient noise reaches FF mic 110 and may, in an attenuated state, reach FB mic 108. Ambient noise 116 reaching FB mic 108, along with any sound from speaker 106, produces signal 118, while any ambient noise 116 reaching FF mic 110 produces signal 120.

Signal 118 and signal 120 are processed by processor 104. Within processor 104, signal 118 may be passed through one or more filters 122, and signal 120 may be passed through one or more filters 124. These filtered signals are then combined with audio signal 126 in combiner 128, and optionally amplified by amplifier 130, to be used as an input to speaker 106.

Filters 122 and/or filters 124 may be digital biquadratic filters (“biquad” or “BQ” filters) which are second order recursive linear filters, or may be other types of filters, which may be used to differentially remove ambient noise 116 from signal 132. Since the removal of ambient noise 116 is happening in parallel with the audio signal 126, there is some time difference between the processing of signals 118 and 120 and the generation of signal 132. This time difference is known as the latency of processor 104. In many systems 100 used for noise-cancelling techniques, the latency of system 100 is often considered adequate when the latency is less than ten microseconds (10 μs).

Combiner 128 may be a mixer, adder, or other combinatorial device used to combine the audio signal 126 with the outputs of filter 122 and filter 124. Further, the combination of audio signal 126 with the outputs of filter 122 and filter 124 can be done in stages, e.g., outputs from filter 122 and filter 124 can be combined first, and then the combined output of filter 122 and filter 124 can be combined with audio signal 126.

One issue with systems 100 that are used in noisy environments is wind noise. Wind noise 134 is not as easily filtered out of signal 132 as are other types of ambient noise 116, e.g., white noise, etc., as wind noise 134 is non-deterministic and harder to predict and/or model. As such, systems 100 may have difficulty removing wind noise 134 from reaching ear 114.

Although described with respect to noise, e.g., ambient noise 116 and wind noise 134, the present disclosure is applicable to any type of interference that may affect audio signal 126. Further, other types of contiguous programs, e.g., data streams, video data, etc., that may be affected by various types of noise or interference may benefit from the aspects described in the present disclosure.

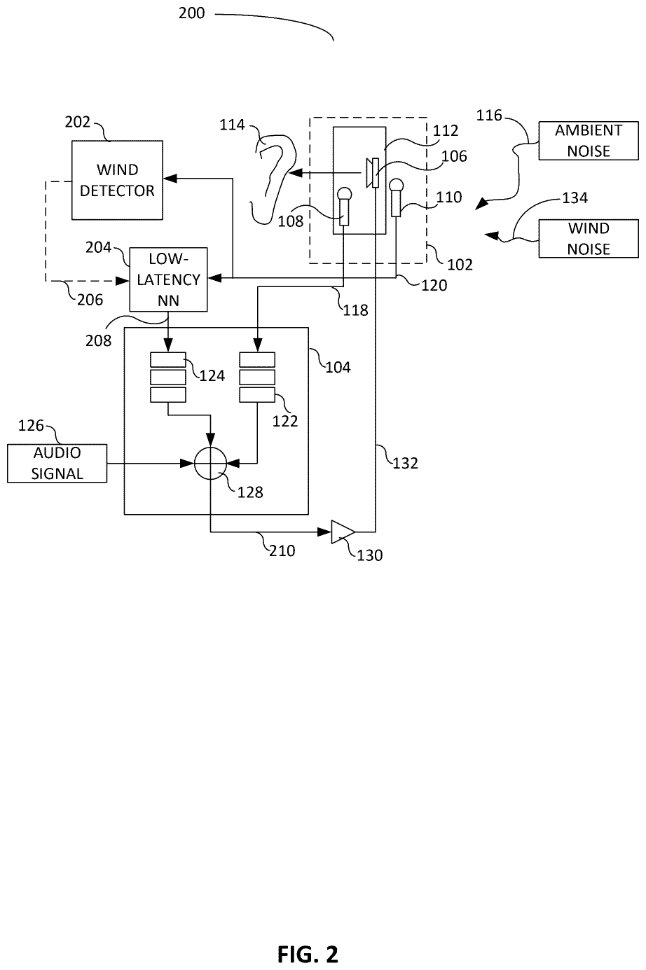

FIG. 2 is a block diagram of a device in accordance with an exemplary aspect of the present disclosure.

System 200 is similar to system 100, however, additional elements are included to assist with wind noise reduction. System 200 may include, inter alia, a wind detector 202 and a low-latency neural network (NN) 204.

Wind detector 202 may be used to determine the presence of wind noise 134 (or other interference that may be present). Wind detector 202 may measure the amount or level of energy present in the lower frequencies that are detected by FF mic 110. Other specified frequency ranges may be used without departing from the scope of the present disclosure. When such energy increases, wind noise 134 may be considered to be present, and the decision to energize low-latency NN 204 may be based at least in part on the wind detector 202 determination of the presence of wind noise 134. Further, statistical algorithms may be embodied in wind detector 202 to help wind detector 202 detect the presence of wind in the environment where system 200 is being used.

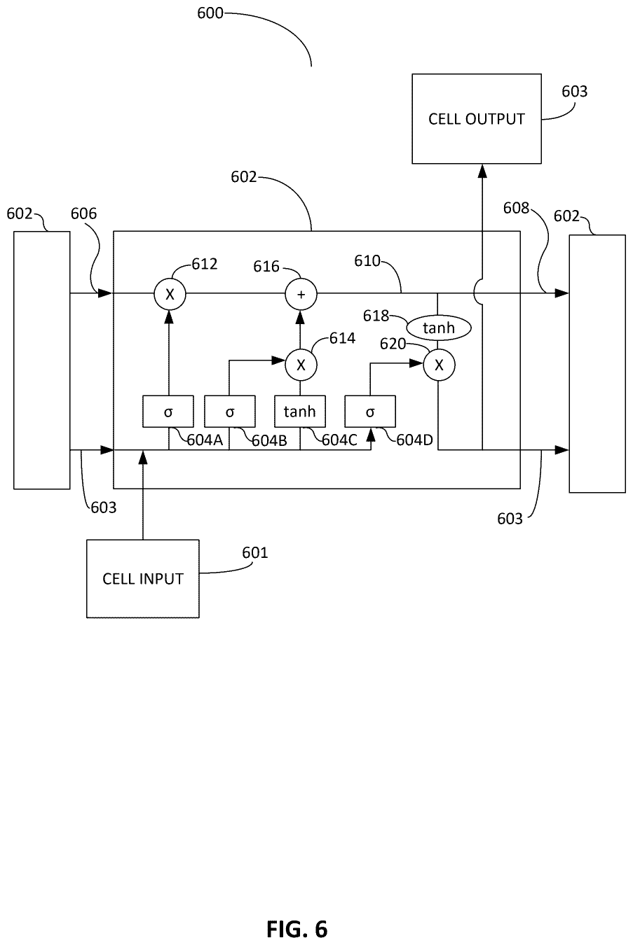

Low-latency NN 204 may be a neural network used for streaming data streams, e.g., audio programming, etc., and may be any kind of neural network. For example, and not by way of limitation, Low-latency NN 204 may be a long short term memory (LSTM) network, a convolutional LSTM (ConvLSTM) network, or other type of neural network, without departing from the scope of the present disclosure. A LSTM network is a recurrent neural network architecture that passes the previous state to the next step of the processing sequence. In other words, the LSTM architecture holds information on previous data seen by the LSTM network before and uses the previous state of the network to make decisions on how to process the present data. An example LSTM network is described with respect to FIG. 6, but other types of neural networks may be used without departing from the scope of the present disclosure.

As shown in FIG. 2, FF mic 110 signal 120 is directed to wind detector 202 and to low-latency NN 204. Signal 120 comprises ambient noise 116 and wind noise 134, while signal 118 comprises the residual ambient noise 116 that penetrates enclosure 112 and audio signal 126.

As shown in FIG. 2, when wind detector 202 detects the presence of wind noise 134, wind detector 202 sends a signal 206 to energize low-latency NN 204 to process signal 120 and feed the NN processed signal 208 to processor 104. In other words, signal 206 acts as an enable/disable signal for low-latency NN 204. If low-latency NN 204 is not enabled, signal 120 is passed through low-latency NN 204 directly to processor 104 without any additional processing.

When wind detector 202 does detect the presence of wind noise 134 and enables low-latency NN 204 to process signal 120 via signal 206, low-latency NN 204 further processes signal 120 to produce NN processed signal 208. In an aspect of the present disclosure, such processing of signal 120 may reduce the impact of wind noise 134 on the output of combiner 128, i.e., signal 210. Signal 210 may thus comprise a noise-cancelled signal with attenuated or eliminated wind noise 134 present in signal 210.

As shown in FIG. 2, low-latency NN 204 is in series with processor 104. Since there is processing time associated with low-latency NN 204, the overall latency of system 200 may be affected. However, low-latency NN 204, in some aspects of the present disclosure, may have a low latency, and even when combined with the latency of processor 104, may still be below the desired latency value. For example, and not by way of limitation, low-latency NN 204 may be a LSTM or a ConvLSTM neural network operating in the time domain, and have a latency less than 5 μs.

Low-latency NN 204 may also be “trained”, i.e., given parameters related to processor 104 and/or filters 122 and filters 124, such that low-latency NN 204 can be paired with certain processors 104 and/or filters 122 and filters 124 used in system 200. For example, and not by way of limitation, the training target for the low-latency NN 204 can be configured as the residual interference after the signals are processed by filters 122 and/or filters 124, which may account for reduction of the ambient noise 116 and introduction of the wind noise 134. Such training could allow for faster, more complete, and/or more desirable responses by system 200 to wind noise 134.

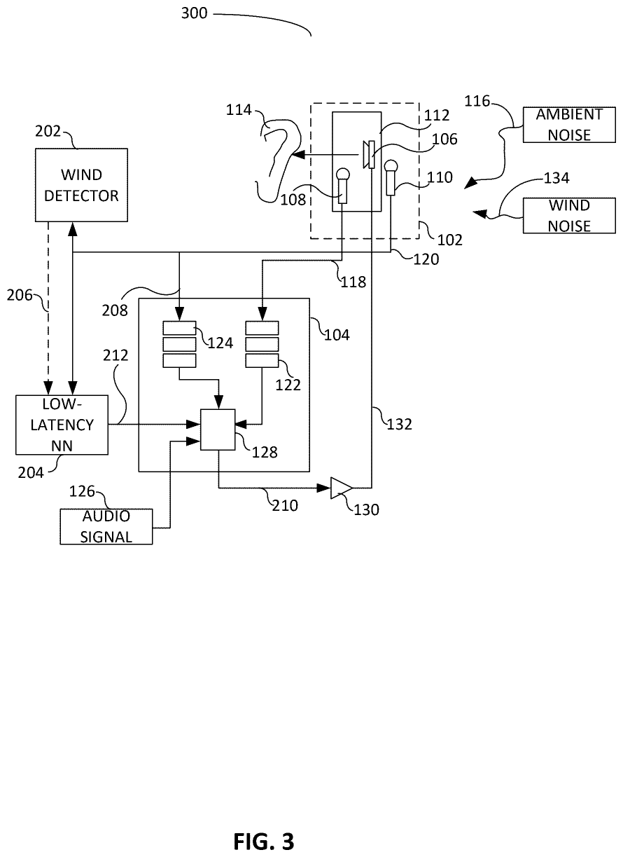

FIG. 3 is a block diagram of a device in accordance with an exemplary aspect of the present disclosure.

System 300 is similar to system 200 and system 100, however, as shown in FIG. 3, a wind detector 202 and low-latency NN 204 are placed in parallel with processor 104 rather than in series with processor 104 as shown in FIG. 2.

System 300 allows for additional latency in both processor 104 and in low-latency NN 204 as these latencies now are in parallel and are not additive in nature. The processing done by processor 104 and the processing done by low-latency NN 204 are done in parallel, and thus would provide a lower overall latency for system 200. Low-latency NN 204 then provides signal 212 directly to combiner 128 rather than to filters 124.

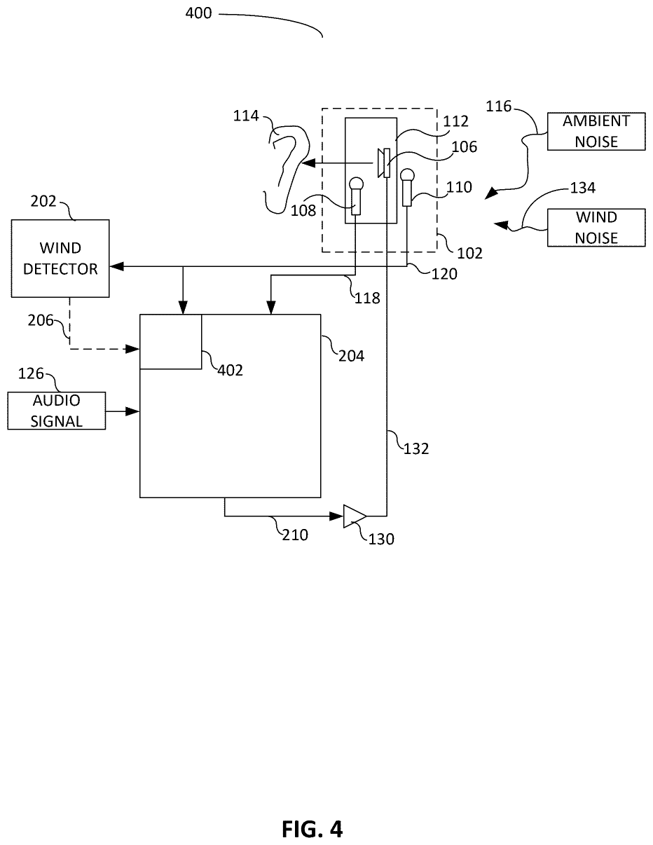

FIG. 4 is a block diagram of a device in accordance with an exemplary aspect of the present disclosure.

System 400 is similar to system 300, system 200, and system 100, however, as shown in FIG. 4, low-latency NN 204 also performs the function of reducing ambient noise.

As shown in FIG. 4, low-latency NN 204 can also perform the functions of processor 104, as well as reducing the effect of wind noise 134 on signal 132. In such an aspect of the present disclosure, wind detector 202 may be used to enable/energize only a portion of low-latency NN 204, e.g., the portion of low-latency NN 204 (shown as portion 402) that processes signal 120 in a manner similar to the manner described in FIGS. 2 and 3.

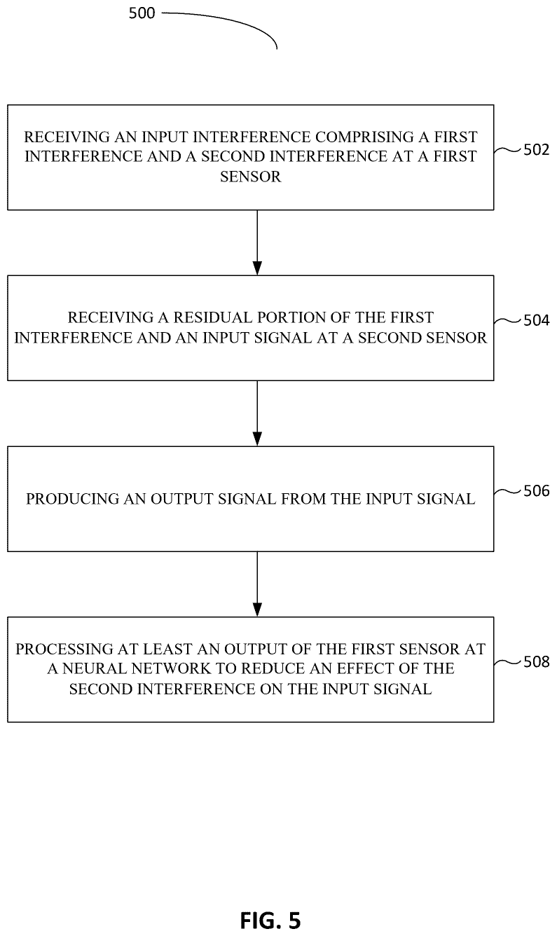

FIG. 5 illustrates a flow diagram in accordance with an exemplary aspect of the present disclosure.

Chart 500 illustrates block 502, 504, 506, and 508. Chart 500 illustrates an exemplary method for reducing interference on a streaming signal. Other methods and variations of the described method are possible within the scope of the present disclosure.

Block 502 represents receiving an input interference comprising a first interference and a second interference at a first sensor. Block 502 may be performed by FF mic 110 receiving ambient noise 116 and wind noise 134 as described in FIG. 3.

Block 504 represents receiving a residual portion of the first interference and an input signal at a second sensor. Block 504 may be performed by FB mic 108 receiving the residual ambient noise 116 and the audio signal 126 as described with respect to FIG. 3.

Block 506 represents producing an output signal from the input signal. Block 506 may be performed by speaker 106 producing the output from audio signal 126 as described with respect to FIG. 3.

Block 508 represents processing at least an output of the first sensor at a neural network to reduce an effect of the second interference on the input signal. Block 508 may be performed by low-latency NN 204 as described with respect to FIG. 3.

FIG. 6 is a diagram of a neural network in accordance with an exemplary aspect of the present disclosure.

Network 600 may comprise, inter alia, a recurrent neural network (RNN) that may be a long short term memory (LSTM) neural network. Although a LSTM neural network is described with respect to FIG. 6, low-latency NN 204 may be an RNN, a LSTM network, a Convolutional LSTM network, or other type of neural network without departing from the scope of the present disclosure.

LSTM networks may be used to model chronological sequences and long-range dependencies of such sequences. LSTM networks may also have more precision than RNN and/or other types of neural networks, as well as being more precise than the BQ filters used in other signal processing networks. In an aspect of the present disclosure, LSTM networks may handle wind noise and/or other types of non-deterministic interferences better than BQ filters and/or other types of neural networks.

As shown in FIG. 6, network 600 may receive an input 601 and comprise cells 602 which are coupled in series. Each cell 602, which may be referred to as a module, a gated unit, or a gated cell, may be repeated a number of times within a given network 600. Although three cells 602 are shown, any number of cells 602 may be included in network 600 without departing from the scope of the present disclosure. Each cell produces an output 603.

Each cell 602 in a LSTM network may comprise four neural network layers 604A, 604B, 604C, and 604D, and accepts the previous cell state 606 to produce the current cell state 608 via pipeline 610. The layers 604A-604D act upon the previous cell state 606 to limit the information that is passed through the cell 602. The current cell state 608 of a given cell 602 may be in the range from 0 to 1 inclusive, where 0 may mean “reject all data” and 1 may mean “include all data”. In an LSTM network, long-term dependencies on the data may be learned or stored by the network 600.

Pipeline 610 conveys the cell 602 state, and is output at current cell state 608. The previous cell state 606 may be affected by gate 612, gate 614, and gate 616, which receive inputs directly or indirectly from layers 604A-604D.

Layers 604A, 604B, and 604D may be sigmoid layers, which may output numbers between 0 and 1. Layer 604C may be a hyperbolic tangent (tanh) layer, which creates new candidates for inclusion in the pipeline 610.

Layer 604A is combined to the previous cell state 606 of the previous cell 602 at gate 612, layer 604B and layer 604C are combined at gate 614 and combined with the output of gate 612 at gate 616. The output of gate 616 (which is the state of the cell 602) is subjected to a tanh operation at gate 618, and layer 604D is combined with the output of gate 618 at gate 620. This combined output of gate 620 is the output 603 of the current cell 602.

Other types of neural networks, such as convolutional LSTM (ConvLSTM), RNN, neural network processing units (NNPUs), or other types of low-latency networks may be used without departing from the scope of the present disclosure.

The previous description is provided to enable any person skilled in the art to practice the various aspects described herein. Various modifications to the exemplary aspects and aspects presented throughout this disclosure will be readily apparent to those skilled in the art, and the concepts disclosed herein may be applied in other contexts and for different purposes. Thus, the claims are not intended to be limited to the exemplary aspects presented throughout the disclosure, but are to be accorded the full scope consistent with the language claims. All structural and functional equivalents to the elements of the exemplary aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f), or analogous law in applicable jurisdictions, unless the element is expressly recited using the phrase “means for” or, in the case of a method claim, the element is recited using the phrase “step for.”

What is claimed is:

1. A device for reducing interference on a streaming signal, comprising:
a first sensor for receiving an input interference comprising a first interference and a second interference;
a second sensor for receiving a residual portion of the first interference and an input signal;
an output device for producing an output signal from the input signal; and
a neural network for processing at least an output of the first sensor to reduce an effect of the second interference on the input signal.

2. The device of claim 1, further comprising a processor for processing the output of the first sensor and an output of the second sensor.

3. The device of claim 2, wherein the processor is a digital signal processor.

4. The device of claim 2, wherein the processor further comprises at least one filter.

5. The device of claim 4, wherein the at least one filter is a biquadratic filter.

6. The device of claim 2, wherein the neural network is coupled to the processor in series.

7. The device of claim 2, wherein the neural network is coupled to the processor in parallel.

8. The device of claim 1, further comprising a detector, coupled to the output of the first sensor and to the neural network, for detecting the second interference.

9. The device of claim 8, wherein the detector enables at least a portion of the neural network when the second interference is detected.

10. The device of claim 1, wherein the second interference comprises an increased energy level within a specified frequency range.

11. The device of claim 1, wherein the second interference is wind noise.

12. The device of claim 1, wherein the input signal is an audio signal.

13. The device of claim 1, wherein the neural network is a long short term memory network.

14. A method for reducing interference on a streaming signal, comprising:
receiving an input interference comprising a first interference and a second interference at a first sensor;
receiving a residual portion of the first interference and an input signal at a second sensor;
producing an output signal from the input signal; and
processing at least an output of the first sensor at a neural network to reduce an effect of the second interference on the input signal.

15. The method of claim 14, further comprising coupling a processor to the neural network and processing the output of the first sensor and an output of the second sensor at the processor.

16. The method of claim 15, wherein the processor is coupled to the neural network in parallel.

17. The method of claim 16, further comprising detecting the second interference and enabling at least a portion of the neural network based on the detection of the second interference.

18. The method of claim 14, wherein the first sensor and the second sensor are microphones.

19. The method of claim 14, wherein the input signal is an audio signal.

20. The method of claim 14, wherein the neural network is a long short term memory network.
